(19) United States
(12) Patent Application Publication
(10) Pub. No.: US 2011/0320030 A1
(43) Pub. Date: Dec. 29, 2011

(54) Thermal Control of a Proximity Mask and Wafer During Ion Implantation

(75) Inventors: Benjamin Riordon, Newburyport, MA (US); Steven Anella, West Newbury, MA (US)

(73) Assignee: VARIAN SEMICONDUCTOR EQUIPMENT ASSOCIATES, INC., Gloucester, MA (US)

(21) Appl. No.: 12/823,531

(22) Filed: Jun. 25, 2010

(51) Int. Cl. G05D 23/00; G05D 16/00; G05D 7/00

(52) U.S. Cl. 700/121; 700/299; 700/282; 700/301

(57) ABSTRACT

An improved method of processing substrates, such as to create solar cells, is disclosed. The use of shadow masks may cause alignment errors associated with the differing thermal expansion characteristics of the shadow mask and the substrate. To counteract this error, mechanisms are used to insure that the thermal expansion of the shadow mask and the substrate are equal or substantially equal. In some embodiments, the shadow mask is produced with a type and quantity of material so that its thermal expansion matches that of the substrate. In other embodiments, heating and cooling mechanisms are applied to the shadow mask so that its thermal expansion matches that of the substrate. In other embodiments, heating and cooling mechanisms are applied to the substrate so that its thermal expansion matches that of the shadow mask. Furthermore, both the mask and substrate can be heated and/or cooled simultaneously.

### BACKGROUND OF THE INVENTION

Various techniques are used to implant ions into a substrate, such as lithography masks, stencil masks and shadow masks. Shadow masks may be more cost effective than other types of masks for certain applications, as the shadow mask is not in contact with the substrate, and therefore fewer process steps may required. Solar cells, which may use larger geometries than other types of semiconductor devices, are one such application that may benefit by the use of shadow masks.

Solar cells are typically manufactured using the same processes used for other semiconductor devices, often using silicon as the substrate material. A semiconductor solar cell is a device having an in-built electric field that separates the charge carriers generated through the absorption of photons in the semiconductor material. This electric-field is typically created through the formation of a p-n junction (diode) which is created by differential doping of the semiconductor material. Doping a part of the semiconductor substrate (e.g. surface region) with impurities of opposite polarity forms a p-n junction that may be used as a photovoltaic device converting light into electricity.

FIG. 1 shows a top view of a solar cell, while FIG. 2 shows a cross-sectional view. Typically, the top surface of a solar cell 100 is an emitter 130. Below the emitter 130 is a base 140, having the opposite doping profile, thereby forming a p-n junction 120 between the emitter and base. To remove the excited electrons and carriers from the emitter, contacts 150, 151 are placed on the top and bottom surfaces of the solar cell 100, respectively. Since the base 140 does not receive the photons 101 directly, typically contacts 151 are placed along the entire outer surface of the base 140. In contrast, the outer surface of the emitter region 130 receives photons 101 and therefore cannot be completely covered with contacts. However, if the electrons have to travel great distances to the contact, the series resistance of the solar cell increases, which lowers the power output. In an attempt to balance these two considerations; the distance that the free electrons must travel to the contact, and the amount of exposed emitter surface 160; most applications use contacts 150 that are in the form of fingers. The contacts 150 are typically formed so as to be relatively thin, while extending the width of the solar cell. In this way, free electrons need not travel great distances, but much of the outer surface of the emitter 130 is exposed to the photons 101. Typical contacts 150 on the front side of the solar cell 100 are between 40 μm and 200 μm. These contacts 150 are typically spaced between 2-3 mm apart from one another. While these dimensions are typical, other dimensions are possible and contemplated herein.

A further enhancement to solar cells is the addition of heavily doped substrate contact regions. These heavily doped contact regions 170 correspond to the areas where the contacts 150 will be affixed to the solar cell 100. The introduction of these heavily doped contact regions 170 allows much better contact between the solar cell 100 and the contacts 150 and significantly lowers the series resistance of the solar cell. This pattern of including heavily doped regions 170 on the surface of the solar cell 100 is commonly referred to as selective emitter design. These heavily doped regions may be created by implanting ions in these regions or other doping methods such as thermal diffusion or laser doping. Thus, the terms “implanted region” and “doped region” may be used interchangeably throughout this disclosure.

A selective emitter design for a solar cell also has the advantage of higher efficiency due to reduced minority carrier losses through recombination due to lower dopant/impurity dose in the exposed regions of the emitter layer. The higher doping under the contact regions provides a field that collects the majority carriers generated in the emitter and repels the excess minority carriers back toward the p-n junction.

In addition to selective emitter designs, other solar cell designs require patterned doping. Another example is the interdigitated back contact (IBC) cell, which requires offset patterns of n-type and p-type dopants on the back side of the cell.

Such structures are typically made using traditional lithography (or hard masks) and thermal diffusion. An alternative is to use implantation in conjunction with a traditional lithographic mask, which can then be removed easily before dopant activation. Yet another alternative, as described above, is to use a shadow mask or stencil mask in the implanter to define the highly doped areas for the contacts. All of these techniques utilize a fixed masking layer (either directly on the substrate or in the beamline).

All of these alternatives have significant drawbacks. For example, the lithography process contains multiple process steps. This causes the cost of the manufacturing process to be prohibitive and may increase substrate breakage rates. These options also suffer from the limitations associated with the special handling of solar wafers, such as aligning the mask with the substrate and the cross contamination with materials that are dispersed from the mask during ion implantation.

While shadow masks eliminate some of these drawbacks, there are many known problems with the use of a proximity mask. FIG. 3 shows a substrate 301 being implanted by an ion beam 302, through a proximity mask 303. The mask 303 has a plurality of slots 307 having a slot width 320, where each is separated from the adjacent slots by a slot-location spacing 300. The first of these slots is offset from an indicia 304 by a distance 310. The mask 303 has a certain thickness (t) and is offset vertically above the substrate 301 by a gap. As shown in FIG. 3, the ion beam 302 may not be completely orthogonal to the substrate 301. The beam angle (θ), the mask thickness (t) and the gap from the mask 303 to the substrate 301 all have an effect on the location of the implanted regions 305. For example, the greater the gap between the mask 303 and the substrate 301, the more lateral displacement between the desired implant region and the actual implanted region 305. Similarly, a thicker mask 303 will tend to reduce the overall width of the implanted region 305, to a width less than the slot width 320. In addition, the use of a mask 303 requires multiple alignment steps. First, the mask 303 must be aligned with the substrate 301. Subsequently, the metal layer has to be aligned as well. FIG. 3 shows the metal 306 applied in the desired location, though this may be applied after removal of the mask 303. However, the variability of the steps creates a situation where the metal 306 is not applied over the center of the implanted region 305. The offset from the implanted region 305 to the metal 306 is referred to as feature error, and is shown as being positive on the left side of the implanted region 305 and negative on the right side of the implanted region 305.

In summary, proximity masks can cause any of the following problems:
Variability of desired feature placement due to machining tolerances;
Variability of feature placement due to incident ion beam angle accuracy (resulting from mask gap or ion beam repeatability);
Variability of feature placement due to substrate positioning;
Variability of feature placement due to substrate size tolerances; or
Tight alignment requirement for the application of metallization.

In addition, there are potential misalignment issues caused due different thermal expansion characteristics of the mask, as compared to the substrate. For example, during ion implantation, the shadow mask is preferably placed in the path of the ion beam, and therefore is subjected to bombardment by the ion beam. Similarly, the ions that pass through the shadow mask impact the substrate. These collisions impart thermal energy on the surfaces of the shadow mask and the substrate. This thermal load may be proportional to the energy of the ions (e.g. beamline voltage) and the number of ions that impact the surface.

Therefore, the shape of the shadow mask determines the thermal load for both the mask and the substrate. For example, if the shadow mask has large slots that allow a large percentage of the ions to pass through the shadow mask and impact the substrate, more thermal load will be created on the substrate than at the mask. Conversely, if the mask blocks a large percentage of the ions, the mask will bear a greater thermal load than the substrate.

The thermal load may cause an increase in the temperature of the mask or substrate. The amount of this temperature increase is related to the characteristic thermal properties (such as specific heat) of each material, the mass of the mask and substrate, and any other thermal loads or drains on the mask and substrate. For example, back side gas is often used to cool a substrate during implantation. This gas will serve to reduce the thermal effects of the ion implantation on the substrate.

As the mask and substrate independently increase in temperature, their respective rates of thermal expansion may differ, causing a further misalignment of the mask aperture relative to the desired implant region. For example, if the mask expands at a faster rate than the substrate, the slots will expand, relative to the substrate beneath them. Thus, the implanted region may change. Conversely, if the mask expands at a slower rate than the substrate, the slots will decrease, relative to the substrate beneath them. Again, the implanted region may change. Misalignment of the implanted region may lead to lower solar cell efficiency or even a non-functioning solar cell. This may increase manufacturing costs or reduce manufacturing yield.

To accommodate these system tolerances, often the implanted region 305 is larger in size than optimally desired. In the case of selective emitter cells, the oversized implanted regions 305 expand into the emitter region, thereby reducing the surface area of the emitter region. This results in a lower cell efficiency.

FIGS. 4A-C show the impact of these wider implanted regions on a solar cell 400. FIG. 4A shows a typically geometry of a solar cell with busbars 405 and contacts 410. FIG. 4B is an expanded view of a portion of FIG. 4A, showing the contacts 410, busbar 405 and implanted regions 415 in more detail. To ensure that the contacts 410 and busbars 405 do not cover the emitter region 420, the implanted regions 415 are created with a greater width than desired. Note that any area which is implanted and not covered by metal, such as by the contacts 410, is less efficient in capturing solar energy.

FIG. 4C shows a section view of an existing process. The contact 410 is located at the leftmost position, based on known tolerances. To ensure that the metal finger 410 does not contact the emitter region 420, the implanted region 415 is made wide enough such that in all scenarios, with maximum tolerances and minimum widths, the contact is covering only implanted region 415. However, the exposed portions of implanted region 415 are less efficient in capturing solar energy.

Therefore, there exists a need to produce solar cells maintaining adequate accuracy in the presence of error sources, such as thermal expansion. While applicable to solar cells, the techniques described herein are applicable to other doping applications.

### SUMMARY OF THE INVENTION

An improved method of processing substrates, such as to create solar cells, is disclosed. The use of shadow masks may cause alignment errors associated with the differing thermal expansion characteristics of the shadow mask and the substrate. To counteract this error, mechanisms are used to ensure that the thermal expansion of the shadow mask and the substrate are equal or substantially equal. In some embodiments, the shadow mask is produced with a type and quantity of material so that its thermal expansion matches that of the substrate. In other embodiments, heating and cooling mechanisms are applied to the shadow mask so that its thermal expansion matches that of the substrate. In other embodiments, heating and cooling mechanisms are applied to the substrate so that its thermal expansion matches that of the shadow mask. Furthermore, both the mask and substrate can be heated and/or cooled simultaneously.

### BRIEF DESCRIPTION OF THE FIGURES

FIG. 1 shows a top view of a solar cell;

FIG. 2 shows a cross section of a solar cell using selective emitter design;

FIG. 3 shows the sources of inaccuracy with a proximity mask;

FIGS. 4A-C show the relative widths and positions of implanted regions and metal layers according to the prior art;

FIGS. 5A-B are flowcharts of the process in accordance with two embodiments;

FIG. 6 is a system in accordance with one embodiment;

FIG. 7 is a system in accordance with another embodiment; and

FIG. 8A-8C show a mask as it is thermally expanded.

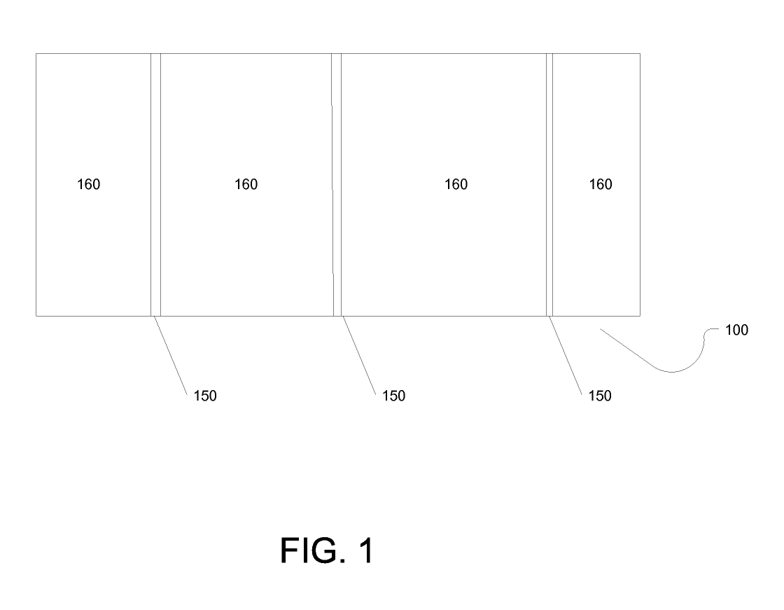

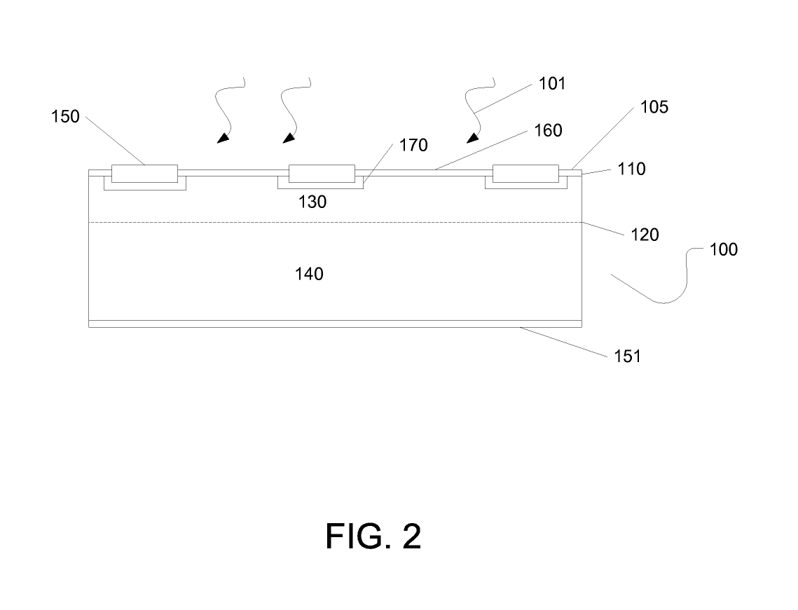

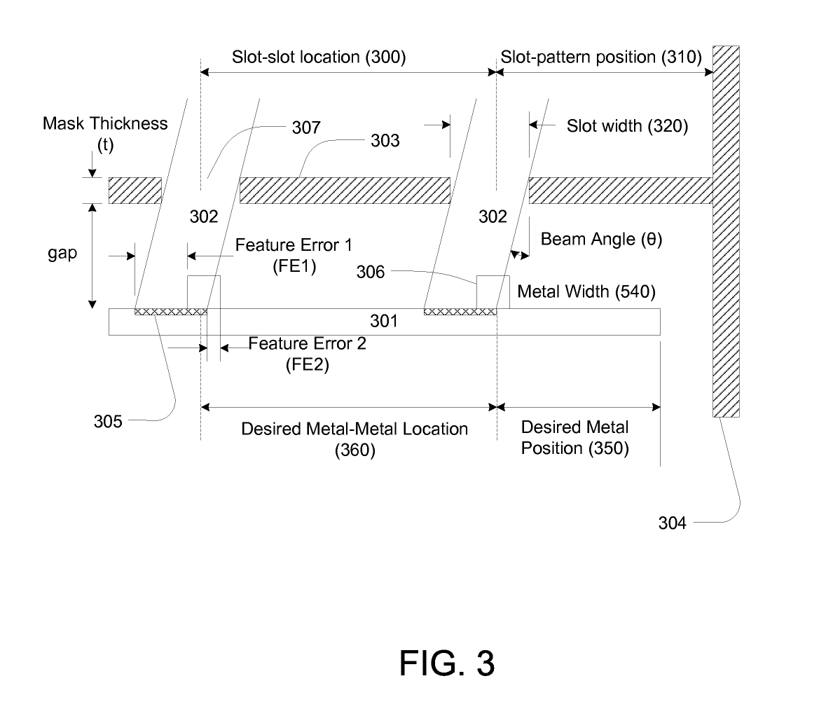

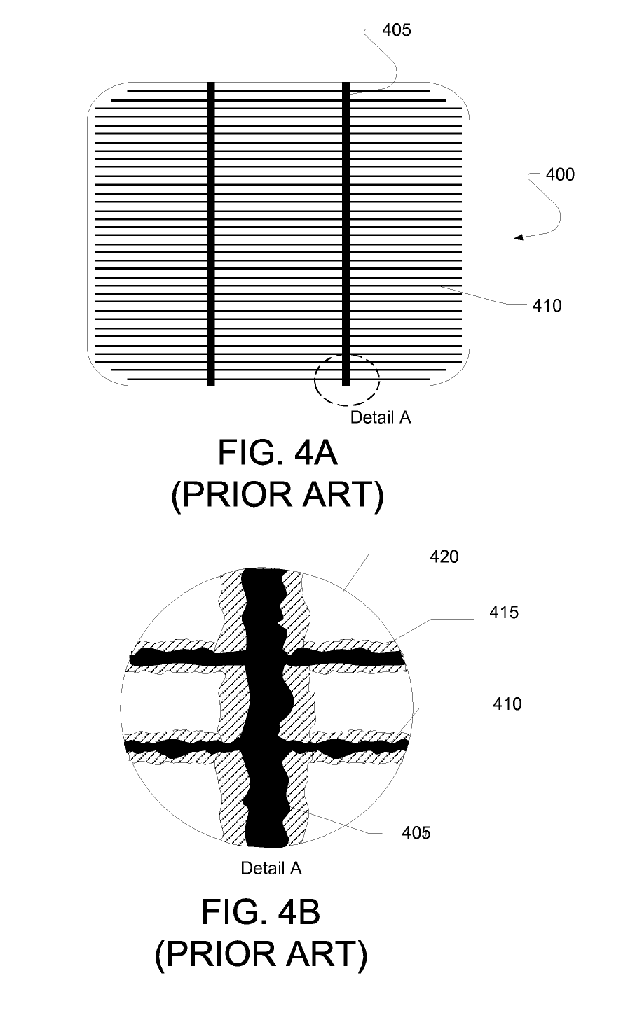

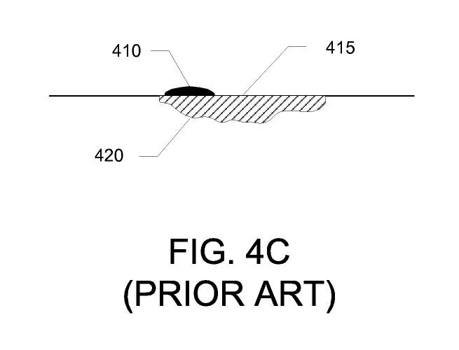

### DETAILED DESCRIPTION OF THE INVENTION

As described above, the use of shadow masks can introduce various alignment errors in the ion implantation process. Some of these errors are caused by differences in the thermal expansion of the shadow mask, as compared to the substrate. To minimize alignment issues causes by differences in thermal expansion, it may be necessary to match the thermal expansion of the shadow mask to that of the substrate. There are several techniques that can be employed to minimize this source of error.

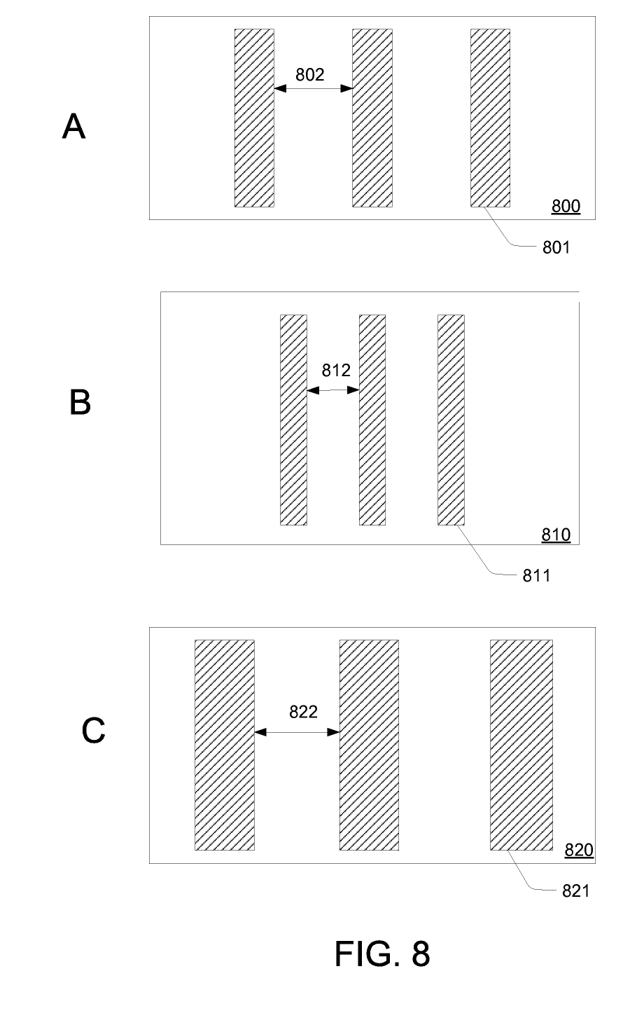

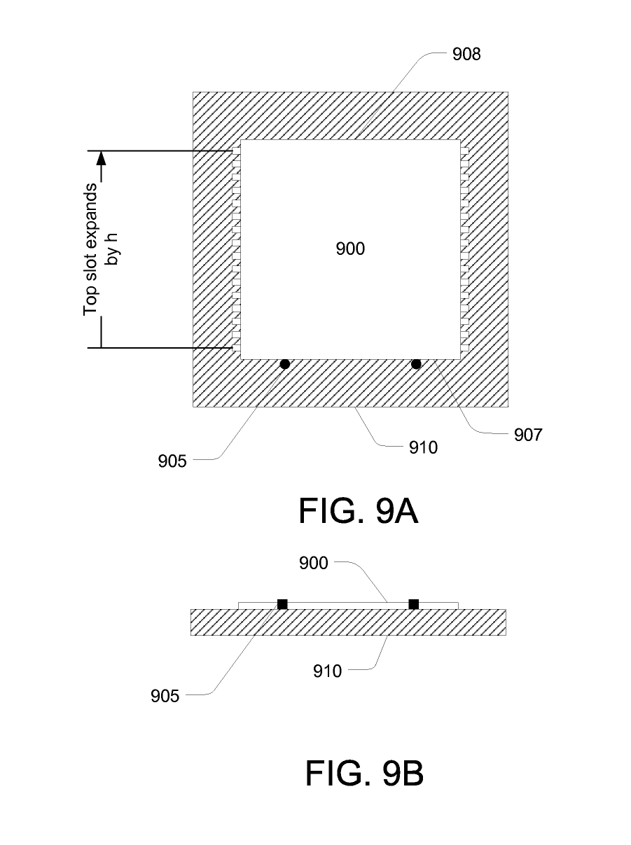

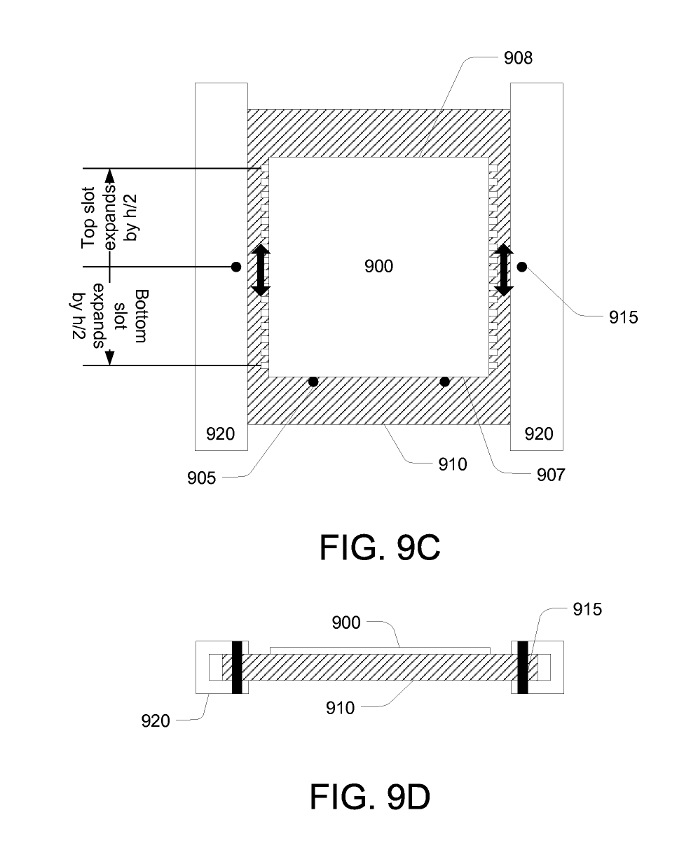

In one embodiment, a passive technique is employed. First, the shape of the shadow mask is defined. Based on this shape, it is possible to determine the amount of thermal load that will be imparted on the shadow mask by the ion beam. Similarly, the openings in the shadow mask also determine the thermal load that will be imparted on the substrate. FIG. 8A shows an exemplary shadow mask 800, in its desired state. Based on the ion beam characteristics, the material used to create the mask, and the time duration of the implant, it is possible to determine the thermal expansion of the mask 800. This expansion, in addition to expanding the mask 800, also increases the width of the slots 801, as well as the pitch 802 between slots 801. Knowing this, a modified mask 810 may created, having narrower slots 811 and smaller pitch 812 between slots 811. Mask 810 represents the size of the mask in its default, or “cool” state. While the modified mask 810 is being used for implantation, it will thermally expand, eventually reaching the size of mask 800, which represents the desired implant pattern.

In some embodiments, the mask 810 is designed such that its final size, at the end of the implant process, is that of the desired mask 800. In other embodiments, it is recognized that the mask 810 will continue to expand throughout the implant process. For example, FIG. 8C shows the mask 820 after full exposure to an ion beam throughout an implant cycle (the “fully heated” state). The slots 821 are expanded, as well as the pitch 822 between slots 821. These dimensions are larger than those of the desired implant pattern. In this case, the mask 810 may be designed such that the average size of the mask as it heats throughout the implant process is the same as mask 800. Thus, the implant pattern that is actually applied to the substrate is a compromise between the smaller, “cool” mask 810, and the expanded “fully heated” mask 820.

Note that the features of masks 800, 810, 820 are exaggerated to show the effect of thermal expansion. The magnitude of the expansion shown in FIGS. 8A-C is purely illustrative.

In some embodiments, the substrate is placed on a platen and held in place, such as by electrostatic forces. To maintain the temperature of the substrate, gas is injected between the front side of the platen and the back side of the substrate. This gas is referred to as backside gas. Based on the thermal load on the substrate, the material used for the platen, the temperature, volume and flow rate of the backside gas, the specific heat capacity of the substrate and other factors, the amount of thermal expansion that will be experienced by the substrate can be calculated.

Based on the theoretically calculated thermal expansion of the substrate, the shadow mask can be modified to match this expansion. There are two factors that affect thermal expansion; the type of material used and the mass of that material. Therefore, the thermal expansion of the shadow mask can be adjusted by varying either of these parameters. In one embodiment, if the thermal expansion of the substrate is determined to be less than that of the shadow mask, additional material can be added to the shadow mask (for example increasing its thickness). This increased mass will reduce its thermal expansion. Conversely, if the thermal expansion of the substrate is determined to be greater than that of the shadow mask, material can be removed from the shadow mask (for example decreasing its thickness). This reduction in mass will increase its thermal expansion rate. In other embodiments, the material used to create the shadow mask can be changed to one with a more appropriate thermal capacity.

In other embodiments, passive techniques, such as those described above, may be inadequate. In these embodiments, the thermal expansion of the shadow mask and/or substrate can be actively controlled. Again, this can be done using a number of techniques. In some embodiments, the active thermal control is applied only to the substrate to match the thermal expansion of the shadow mask. In other embodiments, the active thermal control is applied only to the shadow mask to match the thermal expansion of the substrate. In yet other embodiments, active thermal control is applied to both the shadow mask and the substrate.

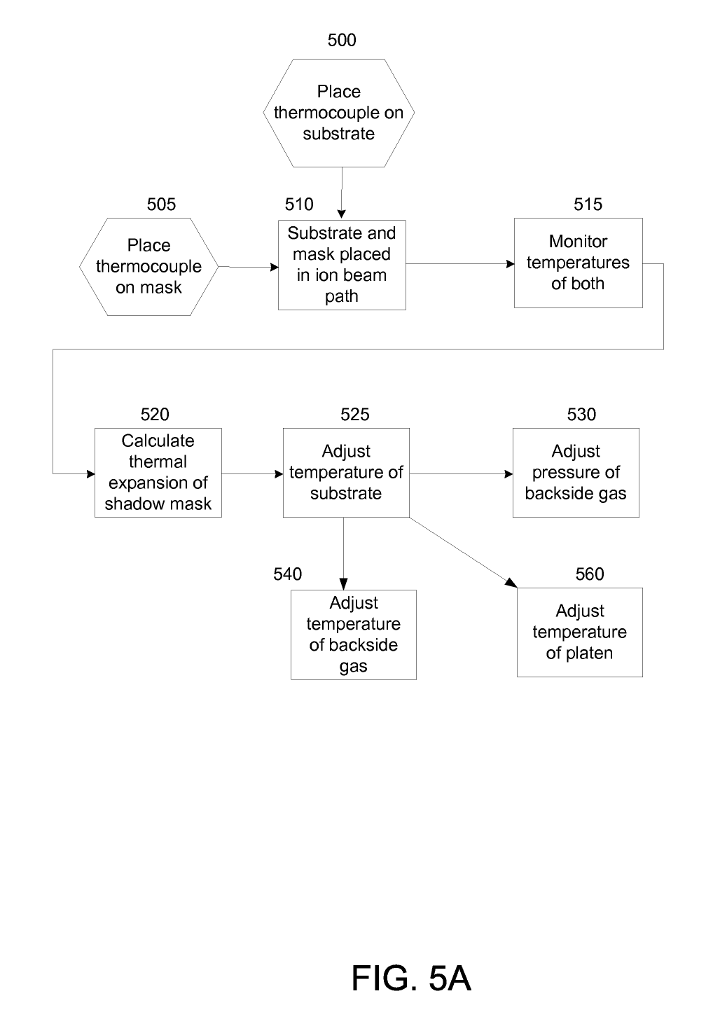

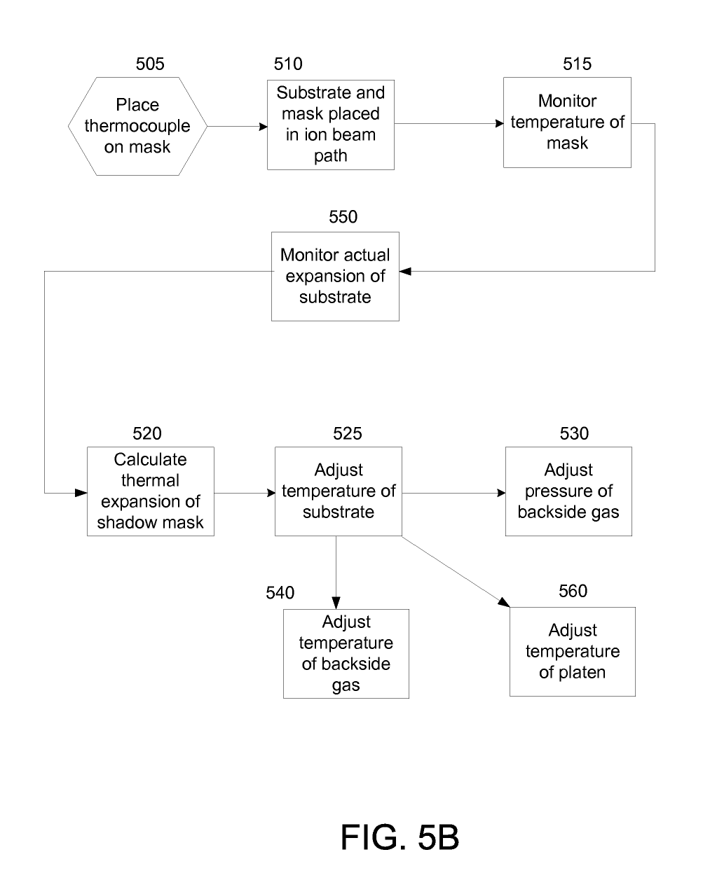

A first embodiment is shown in FIG. 5A. The shadow mask is designed to allow a particular pattern to be implanted into the substrate. The shadow mask and substrate are placed in the path of the ion beam (as shown in step 510). The temperature of each is measured, such as by using a thermocouple (step 515). Knowing the mass and material used for the mask and the substrate, it is possible to determine the thermal expansion for a given temperature. In this embodiment, the temperature of the shadow mask is measured, and the corresponding thermal expansion is calculated (step 520). The substrate is then actively heated or cooled such that its thermal expansion matches that of the shadow mask (step 525). In most ion implanters, the substrate is thermally controlled by the introduction of gas to the back side of the substrate, such as between the substrate and the platen used to hold it. Based on the calculated desired temperature, the temperature or flow rate of the back side gas can be adjusted (step 540). For example, the backside gas may be heated or cooled as necessary so that the substrate reaches the desired temperature, and thermal expansion. Alternatively or additionally, the pressure of the backside gas can be adjusted to affect the temperature of the substrate (step 530).

In operation, a thermocouple is placed directly on the shadow mask (step 505) and is used to determine the temperature of the mask. Using this measured information, in conjunction with known information such as the specific heat of the material and its mass, the amount of thermal expansion is calculated. A second thermocouple is used to measure the temperature of the substrate (step 500). Again, using this information, its mass and specific heat, the thermal expansion of the substrate can be determined. If the thermal expansion of the substrate is less than that of the shadow mask, the backside gas can be heated to increase the temperature of the substrate (step 540). Alternatively, or additionally, the pressure of the backside gas can be decreased, allowing the substrate to heat (step 530). Conversely, if the thermal expansion of the substrate is greater than that of the shadow mask, the backside gas can be cooled to reduce heat from the substrate (step 540). Alternatively, or additionally, the pressure of the backside gas can be increased (step 530). In some embodiments, the substrate is located on a platen, which may have a controllable temperature. For example, the platen may have channels through which fluid passes, which can be used to increase or decrease the temperature of the platen. The temperature of the platen also serves to affect the temperature of the substrate, and thus can also be adjusted, as shown in step 560.

A second embodiment is shown in FIG. 5B. The steps that are common with the embodiment of FIG. 5A are given identical reference designators. In this embodiment, the temperature of the substrate is not measured. Rather, the thermal expansion of the substrate is measured directly. For example, one edge of the substrate is held rigidly, and the position of the other edge can be measured through any traditional method, such as an optical sensor, a piezo-electric switch, or other means. The change in the position of the other edge of the substrate is used to determine the thermal expansion of the substraet (step 550). Based on the difference between the calculated thermal expansion of the shadow mask (step 520) and the actual expansion of the substrate (step 550), an appropriate adjustment can be made to the temperature of the substrate (step 525), such as by adjusting the temperature (step 540) or the pressure (step 530) of the backside gas.

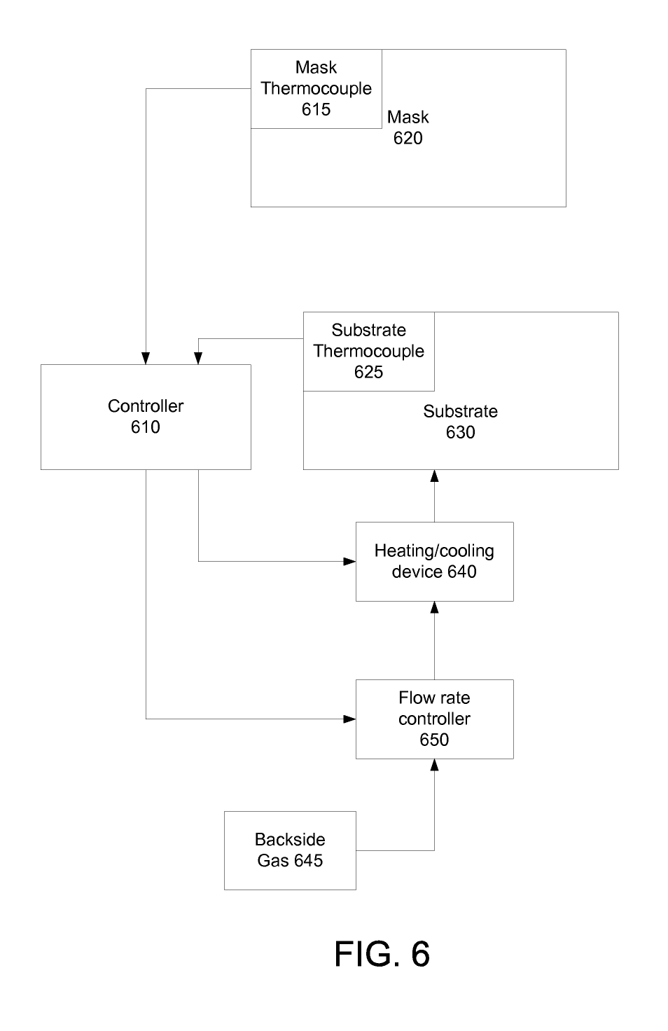

The system 600, shown in FIG. 6, may include a controller 610, which operates using closed loop control, such as via a PID loop, to monitor the temperature of the shadow mask and substrate and adjust backside gas characteristics accordingly. The controller may include a memory element, which may contain both volatile and non-volatile portions. In some embodiments, the instructions to be executed by the controller are stored in the non-volatile portion, while other data is stored in the volatile portion. The controller may also include an A/D controller and a D/A controller for converting digital signals to analog voltages, and vice versa. By executing the instructions stored in the memory element, the controller 610 receives values from the mask thermocouple 615, which are indicative of the temperature of shadow mask 620. These values may be analog values that need to be converted to a corresponding temperature, such as via a table or equation. The controller 610 also receives input from a substrate thermocouple 625, providing an indication of the temperature of the substrate 630. Based on the value received from the mask thermocouple 615 as well as other characteristic values such as mass and specific heat capacity, the controller 610 may calculate the thermal expansion of the shadow mask 620. The controller 610 then determines the desired temperature of the substrate 630 to match the expansion of the shadow mask. Based on this desired temperature and the actual temperature of the substrate 630, the controller 610 may actuate cooling/cooling device 640 to adjust the temperature of the backside gas 645. Alternatively or additionally, the controller 610 may use flow rate controller 650 to adjust the flow rate of backside gas 645 to the substrate 630. In some embodiments, this control loop operates continuously. In other embodiments, the control loop operates on discrete temperature samples.

While the use of thermocouples is described above, it should be noted that other methods of determining thermal load or expansion may be used. Other devices suitable for measuring temperature can be used. In addition, other devices can be used. For example, a vision system can be used to measure the actual expansion of the shadow mask and/or substrate.

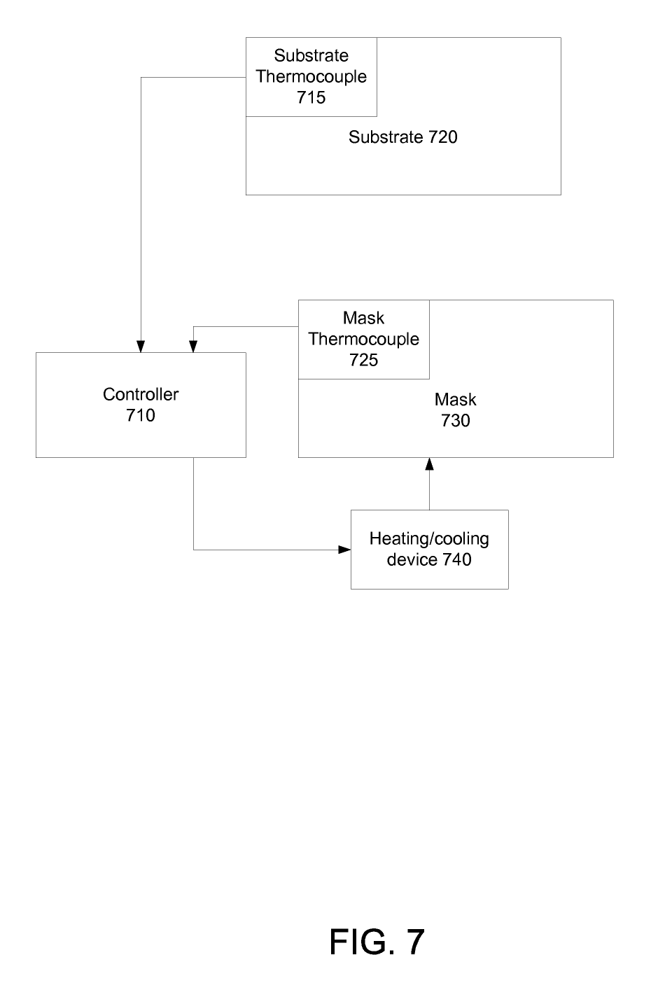

In a second embodiment, shown in FIG. 7, the shadow mask 730 is thermally controlled to match the thermal expansion of the substrate 720. In this embodiment, the substrate 720 is cooled via backside gas (not shown), as is commonly done. The controller 710, having attributes similar to those described above, then measures the thermal expansion of the substrate 720, such as by measuring the temperature using the thermocouple 715 or the actual expansion. Based on the thermal expansion of the substrate 720, the controller 710 actuates a temperature control device 740 to adjust the temperature of the shadow mask 730 to match the thermal expansion of the substrate 720. The temperature control of the shadow mask 730 can be done is a number of ways. For example, the shadow mask 730 may be heated by applying an IR heat lamp as necessary to reach the desired temperature. In other embodiments, the shadow mask can be heated or cooled, such as by water. In another embodiment, a movable shadow for the mask is created so that the exposed portion varies, based on mask temperature. In another embodiment, resistive heating elements are embedded or integrated within the mask. The temperature of the mask can then be increased by passing electrical current through the heating elements. In yet another embodiment, fluid heating or cooling channels are added to the mask. These can be used to control the mask temperature by varying the fluid flow rate and/or the temperature of the fluid.

In another embodiment, the temperatures of both the shadow mask and the substrate are actively controlled. This may be done to control the amount of thermal expansion that occurs. For example, it may be desirable to limit the expansion of the mask and substrate to a predetermined amount. Therefore, it may not be possible to meet this objective by only thermally controlling only the mask or the substrate. In such a case, the controller may independently control the temperature of each, so as to insure that they expand to the same extent, or to limit the amount of expansion that either experiences.

In any embodiment, it may be expected that the shadow mask will experience at least some amount of thermal expansion due to the impact of ions during the implantation process. The design of the shadow mask may compensate for this. For example, if the shadow mask is anticipated to expand by a percentage, such as 5%, the slots in the shadow mask may be intentionally machined to be slightly smaller than the desired thickness, knowing that the effective width and pitch will be different after the shadow mask has been heated.

In another embodiment, the locations of the mask support positions are modified to control thermal expansion. For example, FIG. 9A shows a mask 900, positioned on a platen 910. FIG. 9B shows a cross-section of the mask of FIG. 9A. The mask 900 is supported along one side, using a plurality of pins 905. As the mask is heated, it thermally expands. Since the mask is held fixed along one side 907, all expansion affects the opposite side 908. The change in position of the top and bottom slots as a result of thermal expansion is therefore proportional to the full height of the mask 900.

FIGS. 9C-D show a second embodiment used to support the mask 900. In this embodiment, the mask 900 is initially registered to pins 905, as described above. After registration, the wafer is clamped to the platen 910. The pins 905 are not fixed and are able to move away as the mask 900 expands during implantation. The mask 900 is pinned using pins 915, which are located approximately at the height midpoint of the mask 900. The pins 915 are connected to end channel support 920, which supported the sides of the mask 900. The channel supports 920 are rigidly held in place during the implant process. Thus, the mask 900 is fixed at this location, and thermal expansion occurs from these points 915, in both the up and down directions. As a result, sides 907, 908 each move relative to their starting positions. However, each side moves about half of the total expansion (as opposed to FIG. 9A, where side 908 was affected by all of the expansion). In other words, the change in position of the top and bottom slots as a result of thermal expansion is therefore proportional to the one half of the height of the mask 900. As a result, the implanted regions are less misaligned in this embodiment.

In some embodiments, the temperature change after introduction to the ion beam may cause rapid changes in the size of the mask and/or substrate. In other embodiments, it may be that the mask or wafer is already at an elevated temperature, due to prior use or high temperature storage. One method to minimize these changes is to preheat the wafer and/or mask prior to implantation. This preheat may be done using IR lamps or heated chambers.

The thermal control can be used during various semiconductor processes. For example, it may be desirable to perform a pattern implant on a substrate. The substrate is placed in the path of the ion beam. The shadow mask is placed between the ion beam source and the substrate. The ion beam then passes through the openings in the shadow mask, implanting those portions of the substrate that are exposed to the beam. During the ion implantation process, the thermal control described herein is ongoing, thereby maintaining the thermal expansion within predefined limits.

The present disclosure is not to be limited in scope by the specific embodiments described herein. For example, while a solar cell is specifically mentioned, the substrate may be a semiconductor wafer, LED, flat panel display, or other type of implanted material. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of using a shadow mask, comprising:
placing a shadow mask and a substrate in a path of an ion beam;
monitoring a thermal expansion of said shadow mask with respect to said substrate;
actively controlling a temperature of at least one of said mask and said substrate so as to match said thermal expansion of said shadow mask to said substrate.

2. The method of claim 1, wherein said substrate is located on a platen and a gas is injected between said platen and said substrate and said actively controlling said temperature comprises adjusting a pressure of said gas.

3. The method of claim 1, wherein said substrate is located on a platen and a gas is injected between said platen and said substrate and said actively controlling said temperature comprises adjusting a temperature of said gas.

4. The method of claim 1, wherein said monitoring said thermal expansion is performed by measuring said temperature of said shadow mask and said substrate.

5. The method of claim 1, wherein said actively controlling said temperature comprises adjusting said temperature of said shadow mask.

6. The method of claim 5, wherein said temperature of said shadow mask is adjusted using an IR heat lamp.

7. The method of claim 5, wherein channels are embedded in said shadow mask, fluid is passed through said channels, and said temperature of said shadow mask is adjusted by varying the temperature or flow rate of said fluid.

8. The method of claim 5, wherein resistive heating elements are embedded in said shadow mask, and said temperature of said shadow mask is adjusted by varying the current through said resistive heating elements.

9. A system for processing a semiconductor substrate using a shadow mask, comprising:
a first device, located proximate to said shadow mask, configured to generate a first signal indicative of a thermal expansion of said shadow mask;
a second device, located proximate to said substrate, configured to generate a second signal indicative of a thermal expansion of said substrate;
a third device configured to modify a temperature of at least one of said shadow mask and said substrate; and
a controller in communication with said first and second devices, comprising instructions adapted to: calculate said thermal expansion of at least one of said shadow mask and said substrate using said first signal and said second signal, determine a desired temperature of at least one of said shadow mask and said substrate, and actuate said third device to modify said temperature of at least one of said shadow mask and said substrate to said desired temperature.

10. The system of claim 9, wherein said first device comprises a thermocouple.

11. The system of claim 9, wherein said second device is selected from the group consisting of a thermocouple, piezo-electric switch and an optical sensor.

12. The system of claim 9, wherein said controller calculates the thermal expansion of said shadow mask, and said third device modifies the temperature of said substrate.

13. The system of claim 12, further comprising a platen configured to hold said substrate, wherein a gas is injected between said platen and said substrate and wherein said third device is configured to modify the temperature of said gas.

14. The system of claim 12, further comprising a platen configured to hold said substrate, wherein a gas is injected between said platen and said substrate and wherein said third device is configured to modify the pressure of said gas.

15. The system of claim 12, further comprising a platen configured to hold said substrate, and wherein said third device is configured to modify the temperature of said platen.

16. The system of claim 9, wherein said instructions are adapted to calculate the thermal expansion of said substrate, and said third device is configured to modify said temperature of said shadow mask.

17. The system of claim 9, wherein said instructions are adapted to calculate the thermal expansion of said substrate, and said third device is configured to modify said temperature of said substrate.

18. The system of claim 9, wherein said instructions comprise a PID loop configured to control said third device.
